(19) United States
(12) Patent Application Publication
(10) Pub. No.: US 2019/0070569 A1
(43) Pub. Date: Mar. 7, 2019

(54) COMPOSITE SEMIPERMEABLE MEMBRANE, COMPOSITE SEMIPERMEABLE MEMBRANE ELEMENT, AND METHOD OF MANUFACTURING COMPOSITE SEMIPERMEABLE MEMBRANE

(71) Applicant: Toray Industries, Inc., Tokyo (JP)

(72) Inventors: Koji Nakatsuji, Otsu-shi (JP); Masahiro Kimura, Otsu-shi (JP); Takao Sasaki, Otsu-shi (JP); Takafumi Ogawa, Otsu-shi (JP)

(21) Appl. No.: 16/182,957

(22) Filed: Nov. 7, 2018

Related U.S. Application Data
(62) Division of application No. 14/009,285, filed on Oct. 1, 2013, now abandoned.

(30) Foreign Application Priority Data
Apr. 1, 2011 (JP) 2011-081618

(51) Int. Cl. B01D 71/56; B01D 69/10; B01D 69/12; B01D 63/10

(52) U.S. Cl. CPC B01D 71/56; B01D 69/10; B01D 69/12; B01D 2323/12; B01D 2325/30; B01D 2325/04; B01D 69/125; B01D 63/10

(57) ABSTRACT

A method of producing a composite semipermeable membrane includes forming a porous support by applying polymer solution forming a first layer and polymer solution forming a second layer on a substrate; immersing the substrate in a non-solvent; and forming a separation functional layer the porous support membrane using an aqueous solution containing polyfunctional amine and an organic solvent solution containing a polyfunctional acid halide; wherein the first layer is formed to contact the substrate; the second layer is formed to contact the separation functional layer; the polymer solutions contain polysulfone; the concentration of polysulfone in a polymer solution A is 12% or more and 18% or less by weight; the concentration of polysulfone in a polymer solution B is 14% or more and 25% by weight or less; and the polysulfone concentration of the polymer solution B is greater than the polymer concentration of the polymer solution A.

### TECHNICAL FIELD

This disclosure relates to a method of producing composite semipermeable membrane useful in selective separation of a liquid mixture. The composite semipermeable membrane can be suitably used in desalination, for example, of sea water or brackish water.

### BACKGROUND

Regarding separation of a mixture, there are various techniques for removing substances (for example, salts) dissolved in a solvent (for example, water), and the use of a membrane separation process as a process for energy saving and resource saving has recently been expanding. Examples of membranes used in the membrane separation process include microfiltration membrane, ultrafiltration membrane, nanofiltration membrane, and reverse osmosis membrane. These membranes are used to obtain drinking water from, for example, sea water, brackish water, or water containing hazardous substance, and in production of industrial ultrapure water, effluent treatment, or recovery of valuables.

Most of the current commercially available reverse osmosis membranes and nanofiltration membranes are composite semipermeable membranes. Two types of the composite semipermeable membranes are available: one having, on a porous support membrane, a gel layer and an active layer in which polymers are cross-linked; and the other having, on a porous support membrane, an active layer obtained by polycondensating monomers. Above all, a composite semipermeable membrane obtained by coating a porous support membrane with a separating functional layer composed of cross-linked polyamide obtained by polycondensation reaction of polyfunctional amines with polyfunctional acid halides has been widely used as a separation membrane having high permeability and selective separation properties.

In reverse osmosis membranes used in water generation plants, higher water permeation performance is demanded to further reduce operating costs. For such a demand, a method comprising bringing a composite semipermeable membrane provided with cross-linked polyamide polymer as a separation active layer into contact it with an aqueous solution containing nitrous acid is known (Japanese Patent Application Laid-Open Publication No. 2007-090192). This treatment can improve the water permeation performance of the composite semipermeable membrane while maintaining a boron removal rate before the treatment. Yet higher water permeation performance has been demanded.

Further, examples of factors that affect the water permeability of composite semipermeable membranes include the protuberance structure of the separation active layer. It is suggested that enlarging protuberances increases substantial membrane area and water permeability (Japanese Patent Application Laid-Open Publication No. 9-19630). Addition of various additives at the time of interfacial polycondensation enlarges the protuberances and improves the water permeability, but there is a concern about decrease in a removal rate.

Further, when the composite semipermeable membrane is continuously used, the membrane surface becomes polluted with hours of use, and the amount of water generated by the membrane decreases. That is why chemical washing with acids, alkalis, or the like is required after operation for a certain period of time. Hence, to continue stable operation over a long period of time, it has been desired to develop a composite semipermeable membrane whose membrane performance changes to a small extent before and after washing with acids, alkalis, or the like.

To increase the alkaline resistance of the composite semipermeable membrane, a method comprising bringing a composite semipermeable membrane into contact with an aqueous solution with a concentration of hydrogen ions of pH 9 to 13 is disclosed (Japanese Patent Application Laid-Open Publication No. 2006-102624). Further, to increase the acid resistance of the composite semipermeable membrane, a method comprising bringing a composite semipermeable membrane into contact with cyclic organosulfate is disclosed (Japanese Patent Application Laid-Open Publication No. 2010-234284).

It could therefore be helpful to provide a high-performing composite semipermeable membrane that has high water permeation performance and high chemical resistance, and a method of producing such a membrane.

### SUMMARY

We thus provide:
(1) A composite semipermeable membrane in which a polyamide separation functional layer is formed on a porous support membrane comprising a substrate and a porous support, wherein the standard deviation of the membrane thickness of the separation functional layer is 2.00 nm or less.
(2) The composite semipermeable membrane according to (1) wherein the average membrane thickness of the separation functional layer is 14 nm or more and 22 nm or less.
(3) A composite semipermeable membrane according to (1) or (2) wherein the porous support has a multilayered structure.
(4) A spiral composite semipermeable membrane element in which the composite semipermeable membrane according to any of (1) to (3), a feed spacer and a permeate spacer are wound around a cylindrical collecting pipe provided with a large number of pores by drilling.
(5) A method of producing a composite semipermeable membrane in which a poly-amide separation functional layer is arranged on a porous support membrane comprising a substrate and a porous support, the method comprising forming the porous support by applying polymer solution A forming a first layer and polymer solution B forming a second layer on the substrate at the same time; immersing the substrate in a non-solvent to solidify polymer solution A and polymer solution B; and forming the separation functional layer on the porous support by carrying out interfacial polycondensation on the surface of the porous support membrane using an aqueous solution containing polyfunctional amine and an organic solvent solution containing a polyfunctional acid halide, wherein the first layer is formed to contact the substrate, the second layer is formed to contact the separation functional layer, the polymer solution A and B contains polysulfone, the concentration of polysulfone in the polymer solution A is 12% or more and 18% or less by weight, the concentration of polysulfone in the polymer solution B is 14% or more and 25% by weight or less, and the polysulfone concentration of the polymer solution B is greater than the polymer concentration of the polymer solution A.

A high-performing composite semipermeable membrane that has high water permeability and high chemical resistance and whose membrane performance changes to a small extent before and after washing with a chemical solution can thus be obtained. Continuation of stable operations is achievable over a long period of time by using these membranes.

### DETAILED DESCRIPTION

Our composite semipermeable membranes in which a polyamide separation functional layer are formed on a porous support membrane comprising a substrate and a porous support, wherein the standard deviation of the membrane thickness of the separation functional layer is 2.00 nm or less.

In accordance with the composite semipermeable membrane, it is the separation functional layer that substantially has separation performance of ions or the like. The porous support membrane comprises the substrate and porous support, does not substantially have the separation performance and imparts strength to the separation functional layer.

The thickness of the porous support membrane affects the strength of the composite semipermeable membrane and the packing density when the composite semipermeable membrane is made to an element. To obtain sufficient mechanical strength and packing density, the thickness of the porous support membrane is preferably 30 μm or more and 300 μm or less, more preferably 50 μm or more and 300 μm or less, more preferably 50 μm or more and 250 μm or less, and still more preferably 100 μm or more and 250 μm or less. Further, the thickness of the porous support is preferably 10 μm or more and 200 μm or less, more preferably 20 μm or more and 100 μm or less, and still more preferably 30 μm or more and 100 μm or less. The thickness of the substrate is preferably 10 to 250 μm, and more preferably 20 to 200 μm.

The thickness of each of the layers and membranes means an average value unless otherwise stated. The average value indicates an arithmetic average value. That is, the thickness of each of the layers and membranes is determined by calculating an average value of the thick-ness at 20 points, wherein the thickness is measured at 20 μm intervals in a direction perpendicular to the thickness direction (the membrane plane direction) in cross-section observation.

Examples of substrates composing the porous support membrane include polyester-based polymers, polyamide-based polymers, polyolefin-based polymers, and mixtures and copolymers thereof. Because a porous support membrane that is excellent in durability such as mechanical strength, thermal resistance, water resistance or chemical resistance can be obtained, polyester-based polymers are preferred.

The polyester-based polymer is polyester obtained by polycondensation of an acid component and alcohol component. As the acid component, aromatic carboxylic acid such as terephthalic acid, isophthalic acid or phthalic acid; aliphatic dicarboxylic acid such as adipic acid or sebacic acid; alicyclic dicarboxylic acid such as cyclohexanecarboxylic acid; or the like can be used. Further, as the alcohol component, ethylene glycol, diethylene glycol, polyethylene glycol, or the like can be used.

Examples of the polyester-based polymer include polyethylene terephthalate resin, polybutylene terephthalate resin, polytrimethylene terephthalate resin, polyethylene naphthalate resin, polylactic resin and poly butylene succinate resin. Further, examples thereof include copolymers of these resins.

As such a substrate, a substrate comprising fibers is preferably used in view of the strength, uneven forming ability and fluid permeability. As the substrate, a filament non-woven fabric or staple fiber non-woven fabric can be preferably used. In particular, the filament non-woven fabric is excellent permeability when a polymer solution is cast into the substrate and can therefore prevent the peeling-off of the porous support layer. Further, the filament non-woven fabric can prevent ununiform formation of the membrane due to fluffing of the substrate or the like and occurrence of defects such as pinholes and is thus preferred. Furthermore, because a tension is applied in the membrane-forming direction when continuous membrane production of the composite semipermeable membrane is carried out, it is preferred to use the filament non-woven fabric which is more excellent in dimension stability as the substrate.

In a filament non-woven fabric, in view of formability and strength, fibers in the surface layer arranged on the opposite side to the porous support layer is preferably more longitudinally oriented than fibers in the surface layer arranged on the porous support layer side. Such a structure is preferred because the structure allows maintenance of the strength and thus high effects of preventing membrane breakage or the like are attained. On the top of that, at the time of imparting unevenness to the composite semipermeable membrane, the formability of a layered product containing the porous support layer and substrate increases and the uneven configuration of the surface of a composite semipermeable membrane is stabilized. To be more specific, in the filament non-woven fabric, degree of fiber orientation of the surface layer arranged on the opposite side to the porous support layer is preferably 0° to 25°. Further, the difference in the degree of orientation from the degree of fiber orientation in the surface layer arranged on the porous support layer side is preferably 10° to 90°.

In the process of producing the composite semipermeable membrane and the process of producing the element, a heating step is involved and a phenomenon where the heating shrinks the porous support layer or the composite semipermeable membrane occurs. In particular, the shrinking is noticeable in the width direction in which the tension is not applied during the continuous membrane production. The shrinking causes a problem, for example, with the dimension stability and, therefore, the substrate is desirably one that has a low rate of thermal dimensional change. In a non-woven fabric, the difference between the degree of fiber orientation in the surface layer arranged on the opposite side to the porous support layer and the degree of fiber orientation in the surface layer arranged on the porous support side layer is preferably 10° to 90° because thermal change in the width direction can be prevented.

The degree of fiber orientation herein is an index indicating the direction of the fibers of the non-woven fabric substrate composing the porous support layer and refers to the average angle of the fibers composing the non-woven fabric substrate determined when the membrane-forming direction, that is, the longitudinal direction of the non-woven fabric substrate and the direction perpendicular to the film-forming direction, that is, the width direction of the non-woven fabric substrate during continuous membrane production is assumed to be 0° and 90°, respectively. Thus, it is shown that the closer the degree of fiber orientation is to 0°, the more longitudinal the orientation is; and the closer the degree of fiber orientation is to 90°, the more transverse the orientation is.

Ten small pieces of sample were randomly collected from a non-woven fabric, and photographs of the surface of the sample were taken at a magnification of 100-fold to 1,000-fold with a scanning electron microscope. For 10 fibers from each of the samples, 100 fibers in total, the angle was measured taking the longitudinal direction (lengthwise direction) of the non-woven fabric as 0° and the width direction (transverse direction) of the non-woven fabric as 90°, and the average value thereof was rounded to the whole number to determine the degree of fiber orientation.

As a material of a porous support composing the porous support membrane, a homopolymer or copolymer of polysulfone, polyether sulfone, polyamide, polyester, cellulosic polymer, vinyl polymer, polyphenylene sulfide, polyphenylene sulfide sulfone, polyphenylene sulfone, polyphenylene oxide, or the like can be used solely or blended to be used. As the cellulosic polymer cellulose, acetic acid cellulose, nitric acid cellulose, or the like can be used; and, as the vinyl polymer, polyethylene, polypropylene, polyvinyl chloride, polyacrylonitrile, or the like can be used. Among these, preferred is a homopolymer or copolymer of polysulfone, polyamide, polyester, acetic acid cellulose, nitric acid cellulose, polyvinyl chloride, polyacrylonitrile, polyphenylene sulfide, polyphenylene sulfide sulfone, or the like. More preferred examples include acetic acid cellulose, polysulfone, polyphenylene sulfide sulfone, and poly phenylene sulfone. Further, among these materials, polysulfone is highly stable chemically, mechanically and thermally and is easy to be molded; and therefore can be most preferably used.

To be specific, it is preferred to use polysulfone comprising the repeating unit shown in the following chemical formula because of the easiness of controlling the pore size and the high dimension stability:

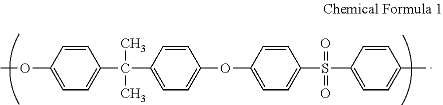

For example, a solution of the above polysulfone in N,N-dimethylformamide (hereinafter referred to as DMF) is applied on a substrate to a uniform thickness, and the resultant is subjected to wet solidification in water, whereby a porous support membrane having micropores with a diameter of a several to 30 nm at most of the surface can be obtained. Using a densely-woven polyester textile or polyester non-woven fabric as a substrate, a polysulfone solution is applied on such a substrate to a uniform thickness, and the resultant is subjected to wet solidification in water, whereby a porous support membrane having micropores with a diameter of several tens of nm at most of the surface can be obtained.

The separation functional layer contains polyamide as a major component. Polyamide composing the separation functional layer can be formed by carrying out interfacial polycondensation of polyfunctional amine and polyfunctional acid halide on the porous support membrane. It is preferred that at least either of the polyfunctional amine or polyfunctional acid halide contain a trifunctional or higher polyfunctional amine or polyfunctional acid halide.

Containing polyamide as a major component means that polyamide accounts for 60% by weight or more in the separation functional layer, preferably 80% by weight or more, more preferably 90% by weight or more and encompasses constitution in which the separation functional layer contains only polyamide.

Polyfunctional amine herein refers to an amine having at least two primary and/or secondary amino groups in one molecule, at least one of the amino groups being a primary amino group. Examples of the polyfunctional amine include aromatic polyfunctional amines such as phenylenediamine or xylylenediamine, in which two amino groups are attached to a benzene ring in any of ortho, meta, and para positional relationship, 1,3,5-triaminobenzene, 1,2,4-triaminobenzene, 3,5-diaminobenzoic acid, 3-aminobenzylamine, or 4-aminobenzylamine; aliphatic amines such as ethylenediamine or propylenediamine; and alicyclic polyfunctional amines such as 1,2-diaminocyclohexane, 1,4-diaminocyclohexane, 4-aminopiperidine, or 4-aminoethylpiperazine. Of these, an aromatic polyfunctional amine having 2 to 4 primary amino groups and/or secondary amino groups in one molecule is preferred in view of the selective separation properties, water permeability, and thermal resistance of the membrane. As such a polyfunctional aromatic amine, a polyfunctional amine selected from m-phenylenediamine, p-phenylenediamine, and 1,3,5-triaminobenzene are suitably used. Among them, it is more preferred to use m-phenylenediamine (hereinafter referred to as m-PDA) for reasons of availability and ease of handling. These polyfunctional amines may be used solely, or two or more of them may be used at the same time. In cases where two or more of them are used at the same time, the above amines may be combined, or the above amine may be combined with an amine having at least two secondary amino groups in one molecule. Examples of the amine having at least two secondary amino groups in one molecule include piperazine and 1,3-bis(piperidyl)propane.

Polyfunctional acid halide refers to an acid halide having at least two halogenated carbonyl groups in one molecule. Examples of trifunctional acid halides include trimesoyl chlor-ide, 1,3,5-cyclohexanetricarboxylic acid trichloride, and 1,2,4-cyclobutanetricarboxylic acid tri-chloride. Examples of bifunctional acid halides include aromatic bifunctional acid halides such as biphenyldicarboxylic acid dichloride, azobenzenedicarboxylic acid dichloride, terephthalic acid chloride, isophthalic acid chloride, or naphthalene dicarboxylic acid chloride; aliphatic bifunctional acid halides such as adipoyl chloride or sebacoyl chloride; and alicyclic bifunctional acid halides such as cyclopentane dicarboxylic acid dichloride, cyclohexanedicarboxylic acid dichloride, or tetrahydrofuran dicarboxylic acid dichloride. In view of reactivity with polyfunctional amines, polyfunctional acid halides are preferably polyfunctional acid chlorides, and in view of the selective separation properties and thermal resistance of the membrane, polyfunctional acid chlorides are preferably polyfunctional aromatic acid chlorides having 2 to 4 carbonyl chloride groups in one molecule. Of these, trimesoyl chloride is more preferably used from the viewpoint of availability and ease of handling. These polyfunctional acid halides may be used solely, or two or more of them may be used at the same time.

The standard deviation of the membrane thickness of a polyamide separation functional layer is 2.00 nm or less.

The membrane thickness of a polyamide separation functional layer can be analyzed using an observation technique with a transmission electron microscope, TEM tomography, focused ion beam/scanning electron microscope (FIB/SEM), or the like. For example, in cases where the observation is carried out with TEM tomography, a composite semipermeable membrane is treated with water-soluble polymer to retain a form of the polyamide separation functional layer and then is stained with osmium tetroxide or the like for carrying out the observation. The polyamide separation functional layer forms a protuberance structure. The shortest distance from a certain point on the external surface of such a protuberance structure to the interior surface is defined as membrane thickness. The standard deviation of the membrane thickness and average membrane thickness of the polyamide separation functional layer are calculated from measurement values of at least 50 sites.

With the standard deviation of the membrane thickness of the polyamide separation functional layer being 2.00 nm or less, high chemical resistance is imparted. If the standard deviation of the membrane thickness of the polyamide separation functional layer is more than 2.00 nm, portions with thinner membrane thickness locally deteriorates at the time of washing with a chemical solution, which readily causes decrease in membrane performance. With the polyamide separation functional layer being uniform and having a standard deviation of the membrane thickness of 2.00 nm or less, local deterioration can be prevented and stable operation is feasible over a long period of time.

Further, the average membrane thickness of a polyamide separation functional layer is preferably 14 nm or more and 22 nm or less and more preferably 16 nm or more and 20 nm or less. If the average membrane thickness is less than 14 nm, sufficient permeate flux is attained but deterioration at the time of washing with a chemical solution is easy to occur. If the average membrane thickness is more than 22 nm, deterioration at the time of washing with a chemical solution can be prevented but sufficient permeate flux is not attained. If the average membrane thickness is 14 nm or more and 22 nm or less, there is balance between the permeate flux and durability against washing with a chemical solution to provide a high-performing membrane.

To make the standard deviation of the membrane thickness polyamide separation functional layer be 2.00 nm or less, it is preferred to use a porous support having a multilayered structure. The porous support having a multilayered structure has at least two layers of a first layer that contacts with a substrate and a second layer that contacts with the polyamide separation functional layer. The first layer preferably has fine pores of a pore size of 0.1 μm or more and 1 μm or less to reduce permeation resistance of water and to impart a good protuberance structure to the polyamide separation functional layer. The second layer preferably has fine pores of a pore size of 1 nm or more and 10 nm or less to retain an amount of polyfunctional amine necessary to form the polyamide separation functional layer and to uniformly release polyfunctional amine in interfacial polycondensation forming the polyamide separation functional layer. We found out that a polyamide separation functional layer that has extremely uniform membrane thickness and small standard deviation of membrane thickness is formed by, as described above, forming the polyamide separation functional layer on such a porous support having the multilayered structure through interfacial polycondensation. The above-mentioned first layer and second layer are not necessarily clearly separated and the interfacial surface between the first layer and second layer may be fused. An area of the first layer with which the substrate makes contact and an area of the second layer with which the polyamide separation functional layer makes contact need only to have fine pores having the above pore size.

As described later, interfacial polycondensation is carried out by bringing a porous support retaining a polyfunctional amine aqueous solution into contact with a polyfunctional acid halide organic solvent solution. That is, the polyfunctional amine aqueous solution is released from the porous support and thereby reacted with the polyfunctional acid halide to form the polyamide separation functional layer. We believe that, by the porous support having the above-mentioned multilayered structure, the polyfunctional amine aqueous solution released from the porous support has a uniform and appropriate flow rate, thereby obtaining a polyamide separation functional layer that has uniform membrane thickness and imparts a good protuberance structure.

The form of the porous support membrane can be observed with a scanning electron microscope, transmission electron microscope, or atomic force microscope. For example, when the observation is carried out with a scanning electron microscope, the porous support is peeled off from a substrate, and this is then cut by freeze fracture technique to prepare a sample for cross-sectional observation. This sample is thinly coated with platinum, platinum-palladium, or ruthenium tetrachloride, preferably with ruthenium tetrachloride, and observed with an ultra-high resolution field-emission scanning electron microscope (UHR-FE-SEM) at an accelerating voltage of 3 to 6 kV. As an ultra-high resolution field-emission scanning electron microscope, S-900-type electron microscope manufactured by Hitachi Ltd. or the like can be used. The membrane thickness and pore size of the porous support membrane are determined from the obtained electron micrograph. The thickness and pore size refer to the average values.

Next, a method of producing the composite semipermeable membrane will be described. A porous support membrane composing the composite semipermeable membrane is formed by applying, onto a substrate, a polymer solution for forming a porous support, followed by solidification.

To obtain, as the porous support as described above, a porous support having a first layer that is excellent in a permeate flow rate after membrane production, and a second layer that retains an amount of polyfunctional amine necessary to form a polyamide separation functional layer having microscopic fine pores for uniformly release the polyfunctional amine, it is preferred that the polymer solution A to form the a first layer and the polymer solution B to form the second layer have different composition.

When the polymer solution A forming a first layer contains polysulfone as a material of porous support, the concentration of polysulfone in the polymer solution A is preferably 12% by weight or more, and more preferably 13% by weight or more. Further, the concentration of polysulfone in the polymer solution A is preferably 18% by weight or less, and more preferably 15% by weight or less. With the polymer concentration being 12% by weight or more, relatively small continuous holes are formed and therefore a pore size that is preferred as the first layer is readily obtained. Further, with the polymer concentration being 18% by weight or less, phase separation sufficiently proceeds before solidification of the polymer, thereby readily obtaining a porous structure.

When the polymer solution B forming a second layer similarly contains polysulfone, the concentration of polysulfone in the polymer solution B is preferably 14% by weight or more, more preferably 15% by weight or more, more preferably 15.5% by weight or more, and still more preferably 16% by weight or more. Further, the concentration of polysulfone in the polymer solution B is preferably 25% by weight or less, and more preferably 18% by weight or less. With the concentration of polysulfone in the polymer solution B being less than 14% by weight, surface fine pores tend to be large, which makes it difficult to uniformly supply an amine solution when a polyamide separation functional layer is formed. Further, with the concentration of polysulfone in the polymer solution B being more than 25% by weight, surface fine pores tend to be small, which makes it difficult to supply an adequate amount of amine solution when the polyamide separation functional layer is formed.

Further, to obtain the porous support having the preferred multilayered structure as described above, the polymer concentration of the polymer solution B is preferably lager than the polymer concentration of the polymer solution A.

With regard to the temperature of the polymer solution at the time of applying the polymer solution, when polysulfone is used, a solution that is 10° C. or more and 60° C. or less may be applied. The temperature of the polymer solution is more preferably 20° C. or more and 35° C. or less. With the temperature of the polymer solution being less than 10° C., polymers are solidified before the phase separation between the polymer and solvent sufficiently proceeds, which makes it difficult to obtain the porous structure. Further, with the temperature of the polymer solution being more than 60° C., the phase separation excessively proceeds and continuous holes tend to be large, which makes it difficult to obtain a predetermined pore size.

In formation of a porous support membrane, it is preferred that the polymer solution A forming a first layer be applied on a substrate at the same time as when the polymer solution B forming a second layer be applied on the first layer. When the polymer solution A is applied and hardened and thereafter the polymer solution B is applied thereon, a highly dense skin layer is formed on the surface of the first layer formed by phase separation of the polymer solution A and the permeate flow rate of the first layer considerably decreases, which is not preferred. It is thus important that the polymer solution B is applied at the same time to the extent that the polymer solution A does not form the highly dense skin layer by the phase separation. The phrase “applying at the same time” herein encompasses a state where the polymer solution A is in contact with the polymer solution B before reaching the substrate, that is, a state where when the polymer solution A is applied on the substrate, the polymer solution B is already applied on the polymer solution A.

The application of the polymer solution on the substrate can be carried out by various coating methods. Pre-measurement coating methods capable of the accurate amount of coating solution such as die coating, slide coating, or curtain coating are preferably employed. Further, in formation of a porous support having a multilayered structure, a double-slit die method comprising applying the polymer solution A forming a first layer and polymer solution B forming a second layer at the same time using a double-slit die coater is more preferably used.

Resins containing the polymer solution A and polymer solution B may be the same resins or may be mutually different resins. By selecting the resin as appropriate, various characteristics such as strength characteristics, permeation characteristics or surface characteristics of a porous support membrane to be produced can be more widely adjusted.

Solvents containing the polymer solution A and polymer solution B may be the same solvents or may be different solvents, as long as they are good solvents of the polymer. In consideration of strength characteristics of a porous support membrane to be produced and impregnation of the polymer solution into a substrate, the solvent can be selected as appropriate.

The good solvent herein refers to one that dissolves a macromolecular material. Examples of the good solvent include N-methyl-2-pyrrolidone, tetrahydrofuran, dimethyl sulfoxide, tetramethyl urea; amides such as dimethylacetamide or dimethylformamide; lower alkyl ketones such as acetone, or methyl ethyl ketone; esters and lactones such as trimethyl phosphate or γ-butyrolactone; and mixed solvents thereof.

Further, the above polymer solution may contain additives to adjust the pore size, porosity, hydrophilicity, elastic modulus, or the like of a porous support membrane to be obtained. Examples of additives to adjust the pore size and porosity include, but not limited to, water, alcohols, water-soluble polymers such as polyethylene glycol, polyvinylpyrrolidone, polyvinyl alcohol, or polyacrylic acid or a salt thereof, inorganic salts such as lithium chloride, sodium chloride, calcium chloride, or lithium nitrate, formaldehyde, and formamide. Examples of additives to adjust hydrophilicity and elastic modulus include various surfactants.

Subsequently, the substrate applied with the polymer solution is immersed in liquid that is a nonsolvent for such a polymer and has miscibility to the solvent and additive; and the polymer solution is thereby solidified to form a porous support.

Examples of the nonsolvent include water; aliphatic hydrocarbons such as hexane, pentane, or trichloroethylene; aromatic hydrocarbons such as benzene or toluene; aliphatic alcohols such as methanol, ethanol, ethylene glycol, diethylene glycol, triethylene glycol, propylene glycol, butylene glycol, pentanediol, hexanediol, or low molecular weight polyethylene glycol; and mixed solvents thereof.

When polysulfone is used as a polymer, water is preferably used as a nonsolvent by ordinary. Yet, the nonsolvent is not particularly restricted as long as it does not dissolve polysulfone. The membrane morphology of a porous support membrane to be obtained varies in the composition of a polymer solution, and thereby the membrane forming properties of a composite semipermeable membrane varies. Further, the temperature of a solidification bath is preferably −20° C. to 100° C. It is more preferred to be 10 to 30° C. With the temperature of the solidification bath being higher than this range, vibration of the surface of solidification bath grows in intensity due to thermal motion and the smoothness of the membrane surface after membrane formation is easy to decrease. In contrast, if the temperature is too low, a solidification rate is low, causing problems in membrane-forming properties.

Next, the obtained porous support membrane is washed with hot water to remove a membrane-forming solvent remaining in the membrane. The temperature of the hot water at this time is preferably 50 to 100° C. and more preferably 60 to 95° C. If the temperature of the hot water is higher than this range, the degree of the shrinkage of the porous support membrane is high and the water permeability decreases. In contrast, if the temperature of the hot water is low, the washing effects are low.

Subsequently, a process of forming a polyamide separation functional layer composing a composite semipermeable membrane will be described. The polyamide separation functional layer can be formed by carrying out interfacial polycondensation on the surface of the porous support membrane using the previously-mentioned aqueous solution containing polyfunctional amine and organic solvent solution containing a polyfunctional acid halide and exhibiting immiscibility with water.

The concentration of polyfunctional amine in a polyfunctional amine aqueous solution is preferably 0.1% by weight or more and 20% by weight or less, and more preferably 0.5% by weight or more and 15% by weight or less. With the concentration of polyfunctional amine being in this range, a membrane to be obtained can have sufficient water permeability and excellent salt and boron removal performance. In the polyfunctional amine aqueous solution, surfactants, organic solvents, alkaline compounds, antioxidants, or the like may be included as long as they do not interfere with a reaction between the polyfunctional amine and polyfunctional acid halide. The surfactant has effects of improving the wettability on the surface of the porous support membrane and reducing the interfacial tension between the aqueous amine solution and organic solvent. The organic solvent can serve as a catalyst for an interfacial polycondensation reaction, and the addition thereof, in some cases, allows the interfacial polycondensation reaction to be carried out in an efficient fashion.

The concentration of polyfunctional acid halide in an organic solvent solution is preferably 0.01% by weight or more and 10% by weight or less, and more preferably 0.02% by weight or more and 2.0% by weight or less. With the concentration being 0.01% by weight or more, a sufficient reaction rate can be attained. With the concentration being 10% by weight or less, occurrence of side reactions can be prevented. Further, it is more preferred to contain an acylation catalyst such as DMF in this organic solvent solution because the interfacial polycondensation is promoted.

The organic solvent is desirably one that dissolves polyfunctional acid halides, does not break the porous support membrane, and is inactive against polyfunctional amine compounds and polyfunctional acid halides. Preferred examples thereof include hydrocarbon compounds such as hexane, heptane, octane, nonane, or decane.

To carry out interfacial polycondensation on a porous support membrane, the polyfunctional amine aqueous solution is first brought into contact with the porous support membrane. The contact is preferably carried out uniformly and continuously on the surface of the porous support membrane. To be specific, examples of methods include a method comprising coating the porous support membrane with the polyfunctional amine aqueous solution and a method comprising immersing the porous support membrane in the polyfunctional amine aqueous solution. The contact time between the porous support membrane and the polyfunctional amine aqueous solution is preferably 5 seconds or more and 10 minutes or less, and more preferably 10 seconds or more and 3 minutes or less.

After the aqueous polyfunctional amine solution has been contacted with the porous support membrane, the solution is sufficiently drained such that droplets do not remain on the membrane. Sufficient draining prevents deterioration in the removal performance of the composite semipermeable membrane due to defects resulting from portions where the droplets remained after formation of the composite semipermeable membrane. As a method of draining, a method comprising holding vertically the porous support membrane after contacted with the polyfunctional amine aqueous solution to allow excess aqueous solution to naturally fall, a method comprising blowing with airflow such as nitrogen from an air nozzle to compulsorily drain the solution, or the like, which are described in Japanese Patent Application Laid-Open Publication No. H02-78428, can be used. Further, after the draining, the membrane surface can also be dried to partially remove the water of the aqueous solution.

Next, the porous support membrane after being contacted with the polyfunctional amine aqueous solution is brought into contact with an organic solvent solution containing polyfunctional acid halides to form a polyamide separation functional layer by interfacial polycondensation. A method of bringing an organic solvent solution containing polyfunctional acid halides into contact with a porous support membrane need only to be carried out in the same manner as a method of coating a polyfunctional amine aqueous solution onto a porous support membrane.

It is crucial that, in the step of interfacial polycondensation, a polyamide separation functional layer sufficiently covers over a porous support membrane; and, during the step of interfacial polycondensation, an organic solvent solution containing polyfunctional acid halides that has been contacted remains on the porous support membrane. Because of this, the amount of time for carrying out the interfacial polycondensation is preferably 0.1 seconds or more and 3 minutes or less, and more preferably 0.1 seconds or more and 1 minute or less. By setting the amount of time for carrying out the interfacial polycondensation to 0.1 seconds or more and 3 minutes or less, the polyamide separation functional layer can sufficiently cover over porous support membrane; and the organic solvent solution containing polyfunctional acid halides that has been can remain on the porous support membrane.

After a polyamide separation functional layer is formed on a porous support membrane by interfacial polycondensation, excess solvents are drained. As a method of draining the solvent, a method comprising holding vertically the membrane to allow excess organic solvents to naturally fall and remove the solvents can be used. In this case, the amount of time for vertically holding the membrane is preferably 1 minute or more and 5 minutes or less, and more preferably 1 minute or more and 3 minutes or less. If the time is too short, a separating functional layer is not completely formed, whereas if the time is too long, the organic solvent is excessively dried and defective portions are generated in the polyamide separation functional layer, leading to decreased performance of membrane to be obtained.

The thus produced composite semipermeable membrane is wound, together with a feed spacer such as a plastic net, a permeate spacer such as a tricot and, if necessary, a film to enhance pressure resistance, around a cylindrical collecting pipe provided with a large number of pores by drilling and suitably used as a spiral composite semipermeable membrane element. Further, this element can be connected in series or in parallel and housed in a pressure container to provide a composite semipermeable membrane module.

Further, the above composite semipermeable membrane, and the element and module thereof can be combined with a pump for supplying feed water thereto and with an apparatus for pretreating the feed water to constitute a fluid separation apparatus. By using this separation apparatus, feed water can be separated into permeate water such as drinking water and concentrated water that has not permeated through the membrane to obtain water for the intended purpose.

The higher the operating pressure of the fluid separation apparatus, the more improved salt removal rate is but the more the energy necessary for operation increases. Considering the durability of the composite semipermeable membrane, the operating pressure during passing the water to be treated through the composite semipermeable membrane is preferably 0.5 MPa or more and 10 MPa or less. The temperature of feed water is preferably 5° C. or more and 45° C. or less, because the higher the temperature is, the more the salt removal rate decreases, but the lower it is, the more the membrane permeate flux decreases as well. Further, when the pH of feed water is high, in the case of feed water of a high salt concentration such as sea water, scale of magnesium or the like might occur, and there is a concern about membrane deterioration due to the high pH operation. Thus, the operation in the neutral range is preferred.

Examples of feed water treated with the composite semipermeable membrane include sea water, brackish water, and liquid mixtures containing TDS (Total Dissolved Solids) of 500 mg/L or more and 100 g/L or less such as effluent. In general, TDS refers to total dissolved solid content and is expressed as “mass/volume” or “weight ratio” on the supposition that 1 L is equal to 1 kg. By definition, it can be calculated from the weight of residue obtained by evaporating the solution filtered through a 0.45 μm filter at a temperature of 39.5° C. or more and 40.5° C. or less, and more conveniently it is converted from practical salinity (S).

The composite semipermeable membrane has high chemical resistance. With regard to an index for the resistance, it is appropriate to use resistance to each of the aqueous solutions of pH 1 and pH 13 as the index. Because pH 1 is the strongest condition as pH at the time of acid washing in membrane filtration operation and pH 13 is the strongest condition as pH at the time of alkali washing, showing the resistance to each of the aqueous solutions of pH 1 and pH 13 ensures that the membrane is difficult to deteriorate even when the washing with acids or alkalis is carried out.

### EXAMPLES

By way of examples, our membranes, elements and methods will now be described in greater detail below, but this disclosure is by no means limited thereto. The average membrane thickness and the standard deviation of membrane thickness of polyamide separation functional layers in the comparative examples and examples were measured as follows.

### Average Membrane Thickness and Standard Deviation of Membrane Thickness of Separation Functional Layer

A composite semipermeable membrane was embedded with PVA and then stained with osmium tetroxide to use as a measurement sample. The obtained sample was imaged by TEM tomography, and the obtained 3D image was analyzed by analysis software. For a TEM tomographic analysis, field emission-type analytical electron microscope JEM2100F manufactured by JEOL Ltd. was used. Using an acquired image at a magnification of 300,000-fold, the shortest distance from a certain point on the external surface of the protuberance structure to the interior surface was defined as membrane thickness; and the analysis was carried out for points of 50 sites per protuberance of the protuberance structure. The above measurement and analysis were carried out for 5 protuberances of the protuberance structure with an accuracy of 0.1 nanometers or better; and the average membrane thickness and the standard deviation of membrane thickness were calculated by the equation 1 and equation 2, respectively, to three significant figures.

$$\begin{matrix}Average membrane thickness = Sum of measured membrane thickness \text{/} The number of samples & ( Equation 1 ) \\ Standard deviation = \sqrt{\frac{\begin{matrix}Sum of ( Measured membrane thickness - \\ {Average membrane thickness )}^{2}\end{matrix}}{The number of samples}} & ( Equation 2 )\end{matrix}$$

The various properties of the composite semipermeable membranes in the comparative examples and examples were determined by carrying out membrane filtration treatment for 3 hours by feeding sodium chloride aqueous solution adjusted to a temperature of 25° C. and a pH of 7 to the composite semipermeable membrane at an operating pressure of 1.55 MPa and measuring thereafter the water quality of the permeate water and feed water.

### Salt Removal Rate

Salt removal rate=100×{1−(salt concentration in permeate water/salt concentration in feed water)}(%)

### Membrane Permeate Flux

From the membrane permeate water volume of the feed water and the area of the composite semipermeable membrane, a permeate water volume per square meter of the membrane area per day, that is, membrane permeate flux (m³/m²/day) was determined.

### Chemical Resistance

A composite semipermeable membrane was immersed in a sodium hydroxide aqueous solution with a pH of 13 for one hour and a sulfuric acid aqueous solution with a pH of 1 for one hour each at room temperature, the operation of which cycle was repeated 20 times; and chemical resistance was evaluated based on changes of a salt removal rate before and after the cycles.

SP ratio=(100−salt removal rate after immersion)/(100−salt removal rate before immersion)

Note that SP is an abbreviation of Substance Permeation.

### Reference Example 1

A polyester non-woven fabric (air permeability 0.5 to 1 cc/cm²/sec) was used as a substrate. As a solution for forming a porous support, 15.7% by weight DMF solution of polysulfone was prepared. The polysulfone solution was cast on the substrate with a thickness of 200 μm at room temperature (25° C.), immersed immediately in pure water and allowed to stand for 5 minutes, thereby producing a porous support membrane (thickness 210 to 215 μm).

### Reference Example 2

The same polyester non-woven fabric as in Reference Example 1 was used as a substrate. A first polysulfone solution (14.0% by weight DMF solution) and second polysulfone solution (17.0% by weight DMF solution) were prepared. Using a double-slit die coater, the first polysulfone solution and second polysulfone solution were discharged at the same time; and the first polysulfone solution was cast on the substrate and the second polysulfone solution was cast on the first polysulfone solution. The first polysulfone solution was cast to have a thickness of 180 μm and the second polysulfone solution was cast to have a thickness of 20 μm; and immersed immediately in pure water and allowed to stand for 5 minutes, thereby producing a porous support membrane.

### Example 1

The porous support membrane obtained in Reference Example 2 was applied with 2.0% by weight aqueous solution of m-PDA and allowed to stand for 2 minutes. Thereafter, nitrogen was blown from an air nozzle to get rid of extra aqueous solution from the surface of the porous support membrane. Subsequently, n-decane solution containing trimesoyl chloride 0.07% by weight was applied thereon such that the surface completely became wet and allowed to stand for 10 seconds. Thereafter, to remove an extra solution from the membrane, the membrane was hold vertically for one minute to drain off the solution. The thus obtained membrane was washed with 90° C. hot water for 2 minutes to obtain a composite semipermeable membrane. With regard to the obtained composite semipermeable membrane, each of the average membrane thickness of a separation functional layer, the standard deviation of membrane thickness, membrane performance and chemical resistance was as shown in Table 1.

### Example 2

A composite semipermeable membrane was obtained in the same method as described in Example 1 except that the concentration of the m-PDA aqueous solution was set to 2.2% by weight and the concentration of the trimesoyl chloride solution was set to 0.08% by weight. With regard to the obtained composite semipermeable membrane, each of the average membrane thickness of a separation functional layer, the standard deviation of membrane thickness, membrane performance and chemical resistance was as shown in Table 1.

### Example 3

A composite semipermeable membrane was obtained in the same method as described in Example 1 except that the concentration of the m-PDA aqueous solution was set to 2.4% by weight and the concentration of the trimesoyl chloride solution was set to 0.08% by weight. With regard to the obtained composite semipermeable membrane, each of the average membrane thickness of a separation functional layer, the standard deviation of membrane thickness, membrane performance and chemical resistance was as shown in Table 1.

### Example 4

A composite semipermeable membrane was obtained in the same method as described in Example 1 except that the concentration of the m-PDA aqueous solution was set to 2.8% by weight and the concentration of the trimesoyl chloride solution was set to 0.1% by weight. With regard to the obtained composite semipermeable membrane, each of the average membrane thickness of a separation functional layer, the standard deviation of membrane thickness, membrane performance and chemical resistance was as shown in Table 1.

### Example 5

A composite semipermeable membrane was obtained in the same method as described in Example 1 except that the concentration of the m-PDA aqueous solution was set to 3.0% by weight and the concentration of the trimesoyl chloride solution was set to 0.1% by weight. With regard to the obtained composite semipermeable membrane, each of the average membrane thickness of a separation functional layer, the standard deviation of membrane thickness, membrane performance and chemical resistance was as shown in Table 1.

### Example 6

A composite semipermeable membrane was obtained in the same method as described in Example 11 except that the concentration of the m-PDA aqueous solution was set to 3.2% by weight and the concentration of the trimesoyl chloride solution was set to 0.1% by weight. With regard to the obtained composite semipermeable membrane, each of the average membrane thickness of a separation functional layer, the standard deviation of membrane thickness, membrane performance and chemical resistance was as shown in Table 1.

### Comparative Example 1

The porous support membrane obtained in Reference Example 1 was applied with 2.2% by weight aqueous solution of m-PDA and allowed to stand for 2 minutes. Thereafter, nitrogen was blown from an air nozzle to get rid of extra aqueous solution from the surface of the porous support membrane. Subsequently, n-decane solution containing trimesoyl chloride 0.08% by weight was applied thereon such that the surface completely became wet and allowed to stand for 10 seconds. Thereafter, to remove an extra solution from the membrane, the membrane was hold vertically for one minute to drain off the solution. The thus obtained membrane was washed with 90° C. hot water for 2 minutes to obtain a composite semipermeable membrane. With regard to the obtained composite semipermeable membrane, each of the average membrane thickness of a separation functional layer, the standard deviation of membrane thickness, membrane performance and chemical resistance was as shown in Table 1.

### Comparative Example 2

A composite semipermeable membrane was obtained in the same method as described in Comparative Example 1 except that the concentration of the m-PDA aqueous solution was set to 3.0% by weight and the concentration of the trimesoyl chloride solution was set to 0.1% by weight. With regard to the obtained composite semipermeable membrane, each of the average membrane thickness of a separation functional layer, the standard deviation of membrane thickness, membrane performance and chemical resistance was as shown in Table 1.

TABLE 1

| | Membrane | | Initial performance | | |
|---|---|---|---|---|---|
| | thickness | | of membrane | | Chemical |
| | | Standard | Salt | Membrane | resistance |
| | Average | deviation | removal | permeate flux | SP |
| | (nm) | (nm) | rate (%) | (m³/m²/day) | ratio |
| Example 1 | 13.8 | 1.78 | 99.5 | 1.41 | 1.27 |
| Example 2 | 14.4 | 1.82 | 99.5 | 1.35 | 1.22 |
| Example 3 | 16.5 | 1.88 | 99.6 | 1.28 | 1.17 |
| Example 4 | 19.3 | 1.91 | 99.6 | 1.14 | 1.16 |
| Example 5 | 21.5 | 1.95 | 99.7 | 0.97 | 1.15 |
| Example 6 | 22.8 | 1.97 | 99.7 | 0.67 | 1.12 |
| Comparative | 14.3 | 2.02 | 99.3 | 1.48 | 2.01 |
| Example 1 | | | | | |
| Comparative | 21.7 | 2.09 | 99.7 | 0.68 | 1.73 |
| Example 2 | | | | | |

As read out from Table 1, it was proven that the composite semipermeable membranes of Examples 1 to 6 in which the standard deviation of the membrane thickness of the separation functional layer is 2.00 nm or less have both high water permeation performance and high chemical resistance, as compared with the composite semipermeable membranes of Comparative Examples 1 and 2 in which the standard deviation of the membrane thickness of the separation functional layer is more than 2.00 nm.

Further, among the composite semipermeable membranes in which the standard deviation of the membrane thickness of the separation functional layer is 2.00 nm or less, the composite semipermeable membranes of Examples 2 to 5 in which the average membrane thickness of the separation functional layer is 14 nm or more and 22 nm or less, in particular, the composite semipermeable membranes of Examples 3 and 4 in which the average membrane thickness of the separation functional layer is 16 nm or more and 20 nm or less are prove to have higher water permeation performance and higher chemical resistance, as compared with the composite semipermeable membranes of Examples 1 and 6.

### INDUSTRIAL APPLICABILITY

Our composite semipermeable membranes can be suitably used particularly in desalination of brackish water and sea water.

1. A method of producing a composite semipermeable membrane in which a polyamide separation functional layer is arranged on a porous support membrane comprising a substrate and a porous support, the method comprising:
forming said porous support by applying polymer solution A forming a first layer and polymer solution B forming a second layer on said substrate at the same time;
immersing said substrate in a non-solvent to solidify polymer solution A and polymer solution B; and
forming the separation functional layer on said porous support by carrying out interfacial polycondensation on the surface of the porous support membrane using an aqueous solution containing polyfunctional amine and an organic solvent solution containing a polyfunctional acid halide;
wherein
said first layer is formed to contact said substrate;
said second layer is formed to contact said separation functional layer;
the polymer solution A and B contains polysulfone;
the concentration of polysulfone in the polymer solution A is 12% or more and 18% or less by weight;
the concentration of polysulfone in the polymer solution B is 14% or more and 25% by weight or less; and
the polysulfone concentration of the polymer solution B is greater than the polymer concentration of the polymer solution A.

2. The method according to claim 1, wherein a standard deviation of a membrane thickness of the separation functional layer is 2.00 nm or less.

3. The method according to claim 2, wherein an average membrane thickness of said separation functional layer is 14 nm or more and 22 nm or less.

4. The method according to claim 1, wherein the concentration of polysulfone in the polymer solution A is 15% or less by weight and the concentration of polysulfone in the polymer solution B is 16% or more.

5. The method according to claim 4, wherein standard deviation of a membrane thickness of the separation functional layer is 2.00 nm or less.

6. The method according to claim 5, wherein an average membrane thickness of said separation functional layer is 14 nm or more and 22 nm or less.
